(19) United States
(12) Patent Application Publication
(10) Pub. No.: US 2004/0100007 A1
(43) Pub. Date: May 27, 2004

(54) Vibration damping devices and methods

(75) Inventors: Mats Anders Engwall, San Juan Batista, CA (US); Andrew J. Hazelton, San Carlos, CA (US)

Correspondence Address: BEYER WEAVER & THOMAS LLP, P.O. BOX 778, BERKELEY, CA, 94704-0778, US

(73) Assignee: Nikon Corporation, Tokyo (JP)

(21) Appl. No.: 10/303,324

(22) Filed: Nov. 21, 2002

(51) Int. Cl. F16F 5/00

(52) U.S. Cl. 267/140.13

(57) ABSTRACT

Vibration of a member supported by another member is damped by detecting the changes in the width of a gap between the members and applying an electrical force between the members in a time-dependent manner. The detection of the changes in the width of the gap may be carried out by an optical displacement sensor or by a capacitive displacement sensor. The electrical force is applied by attaching electrodes on mutually opposite surfaces of the members and connecting them to a voltage source such that their voltages can be varied or to a current source such that mutually parallel and/or antiparallel currents can flow through them. Vibration damping devices structured for using such a vibration damping method can provide shock-absorbing mounts to apparatus of different kinds such as lithography exposure apparatus having an optical frame supported by a base frame, a workpiece being placed on the base frame and the optical frame supporting an optical system for irradiating the workpiece with radiative energy.

### BACKGROUND OF THE INVENTION

This invention relates to devices for and methods of damping vibrations of a member with respect to another member which supports it. More particularly, this invention relates to such devices and methods where the vibrating member and the supporting member have mutually oppositely facing surfaces.

Shock-absorbing mounts are widely used in a variety of applications. Such a mount is particularly important, for example, in an optical apparatus for imaging with a high level of precision.

For manufacturing integrated circuits, it has been known to use lithography photomasks (or reticles) with different patterns together with a photosensitized semiconductor wafer. A reticle is typically a high-precision plate containing a pattern of extremely small images of various components of an electronic circuit and is used as a master for transferring a circuit pattern onto the photosensitized wafer. With a modern lithographic system, an ultra-fine image is frequently required to be positioned with a tolerance of less than 15 nanometers. Current circuit architectures often have conductor line widths as small as 30 nanometers. Accordingly, lithography processing equipment now requires optical and mechanical systems with an improved level of precision, and even higher-precision systems will be required in the near future when still smaller images will become common.

A lithographic exposure apparatus is used to project an image from a reticle onto a photosensitive wafer during a semiconductor manufacturing process. Such a lithographic exposure apparatus typically comprises a base frame having an enclosure which encloses therein a wafer stage for supporting thereon a semiconductor workpiece, or a wafer. The base frame supports an optical device which holds a reticle stage and serves to project an image from a reticle carried on the reticle stage onto the workpiece on the wafer stage. A vibration damping device is usually provided between the base frame and the optical device such that vibrations of various components of the exposure apparatus will not be communicated therebetween.

It should be understood that such a vibration damping device, or a vibration isolating device, is necessary because mechanical vibration transmitted between these components of the exposure apparatus never fails to adversely affect the accuracy of the imaging.

### SUMMARY OF THE INVENTION

It is therefore a general object of this invention to provide a device for and a method for damping vibrations of one member with respect to another member which supports it.

It is another object of this invention to provide a lithography exposure apparatus incorporating such vibration damping devices.

When a member supported by another member vibrates with a gap therebetween, the width of the gap increases and decreases alternately. The vibration can be attenuated and damped if an attractive force is applied across the gap as its width is increasing and/or if a repulsive force is applied as its width is decreasing. According to the present invention, an electrical force such as electrostatic (Coulomb) forces and forces between electric currents flowing parallel or antiparallel to each other are applied in a time-dependent manner according to the phase of the vibration. A displacement sensor such as an optical sensor or a capacitive sensor may be used to detect the phase of the vibration, or whether the width of the gap is increasing or decreasing and to output a signal indicative thereof and the time-dependent vibration-damping force is applied according to such a signal.

Thus, a vibration damping device according to this invention is for damping vibrations of a vibrating member supported by a supporting member, the supporting member having a first surface, the vibrating member having a second surface which is substantially parallel and opposite to and faces the first surface, and may be characterized as comprising a first electrode attached to the first surface of the supporting member, a second electrode attached to the second surface of the vibrating member, the first electrode and the second electrode providing a gap therebetween with a specified width, a displacement sensor that outputs a signal indicative of a change in the width of the gap caused by a vibration of the vibrating member, and a controller connected to the first electrode, the second electrode and the displacement sensor, the controller receiving the signal from the displacement sensor and applying an electrical force between the first electrode and the second electrode according to the signal so as to damp the vibration. The controller may serve to apply a specified voltage to at least one of the first electrode and the second electrode in a time-dependent manner. It may cause electric currents to flow through the first electrode and the second electrode in parallel and antiparallel directions.

The displacement sensor may be a capacitive displacement sensor serving to measure the capacitance between two electrodes affixed individually to the first surface and the second surface or may be an optical displacement sensor.

The controller may include a voltage source that applies a constant voltage and a switch for applying the constant voltage to at least a selected one of the first electrode and the second electrode in the time-dependent manner. The controller may include a voltage source that applies a constant voltage difference and a switch for applying the constant voltage between the first electrode and the second electrode in the time-dependent manner. The controller may further include a current source that causes the electric currents to flow through the first electrode and the second electrode and a switch that passes the currents selectively parallel or antiparallel to each other in a time-dependent manner according to the signal.

The invention also relates to a method of damping vibrations of a vibrating member supported by a supporting member, the supporting member having a first surface, the vibrating member having a second surface which is substantially parallel and opposite to the first surface. A method according to this invention may be characterized as comprising the steps of attaching a first electrode on the first surface of the supporting member, attaching a second electrode on the second surface of the vibrating member, the first electrode and the second electrode providing a gap therebetween with a specified width, generating a signal indicative of a change in the width of the gap caused by a vibration of the vibrating member, and applying an electrical force between the first electrode and the second electrode according to the signal so as to damp the vibration. The electrical force may be an electrostatic force and may be applied by applying a specified voltage to at least one of the first and second electrodes in a time-dependent manner. It may be applied by causing electric currents to flow through the first electrode and the second electrode selectively in parallel and antiparallel directions in a time-dependent manner. The signal may be generated by detecting the gap by an optical sensor or by detecting the gap capacitively by measuring capacitance between two electrodes placed respectively on the first and second surfaces.

The invention relates also to a lithography exposure apparatus incorporating one or more vibration damping devices as described above and also comprising a base frame supporting a workpiece, the base frame including a first member having a first facing surface, and an optical frame supporting optical device that irradiates the workpiece with radiative energy, the optical frame including a second member supported by the first member, the second member having a second surface which is substantially parallel and opposite to the first surface of the first member.

The invention further relates to an apparatus comprising a wafer table having a first electrode. a mirror assembly affixed to the wafer table, the mirror assembly having a second electrode, the first electrode and the second electrode defining a gap between the mirror assembly and the wafer table, a displacement sensor that generates an output signal indicative of a change in the width of the gap caused by vibrations between the wafer table and the mirror assembly, and a controller connected to the first and second electrodes and the displacement sensor, the controller configured to receive the output signal from the displacement sensor and to apply an electrical force between the first electrode and the second electrode according to the output signal.

Vibration damping devices according to this invention can be used as a shock-absorbing support in many situations. In a lithography exposure apparatus, for example, a base frame which supports a workpiece may also support an optical frame for supporting optical means for irradiating the workpiece with radiative energy. Vibration damping device of this invention may be inserted between these frames to efficiently damp the vibration of the optical frame with respect to the base frame which supports it.

### BRIEF DESCRIPTION OF THE DRAWING

The invention, together with further objects and advantages thereof, may best be understood with reference to the following description taken in conjunction with the accompanying drawings in which:

FIG. 1 is a schematic sectional view, being in part a block diagram, of a vibration damping device embodying this invention employing an optical displacement sensor;

FIG. 2 is a schematic sectional view, being in part a block diagram, of another vibration damping device embodying this invention employing a capacitive displacement sensor;

FIG. 3 is a block diagram of a controller which may be used in the vibration damping device of FIG. 1 or 2;

FIG. 4 is a block diagram of another controller which may be used in the vibration damping device of FIG. 1 or 2;

FIG. 5 is a schematic sectional view, being in part a block diagram, of a vibration damping device according to another embodiment of this invention;

FIG. 6 is a schematic sectional view, being in part a block diagram, of another vibration damping device embodying this invention employing a capacitive displacement sensor instead of an optical displacement sensor;

FIG. 7 is a cross-sectional view of a lithographic exposure apparatus incorporating vibration damping devices of this invention;

FIG. 8 is a process flow diagram illustrating an exemplary process by which semiconductor devices are fabricated by using the apparatus shown in FIG. 7 according to the present invention;

FIG. 9 is a flowchart of the wafer processing step shown in FIG. 8 in the case of fabricating semiconductor devices according to the present invention; and

FIG. 10 is a schematic diagonal view of a mirror bar embodying this invention which may be incorporated in a lithographic exposure apparatus such as shown in FIG. 7.

Throughout herein, components which are equivalent or at least similar are indicated by same numerals and may not necessarily be described or explained in a repetitious manner even where they are components of different devices.

### DETAILED DESCRIPTION OF SPECIFIC EMBODIMENTS

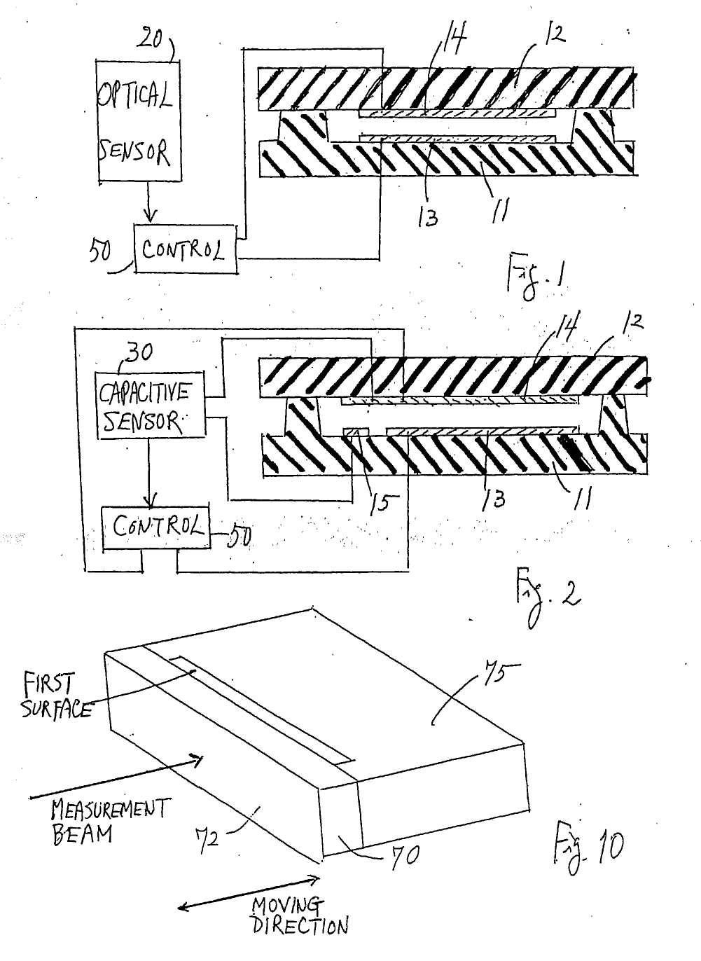

The invention will be described next by way of examples of devices using various methods embodying this invention for damping vibrations of a member supported by another member wherein these two members have a pair of flat surfaces which are opposite and face each other with a small gap in between. FIG. 1 shows schematically an example of such a pair of members. Numeral 11 indicates a supporting member having a upwardly facing flat surface (“the first surface”) and numeral 12 indicates a vibrating member having a downwardly facing flat surface (“the second surface”) which is parallel and opposite to the upwardly facing surface of the supporting member 11 with a gap in between normally with a uniform width. Although FIG. 1 shows an example wherein the vibrating member 12 is supported by protrusions which are separate from each other and integrally formed on the upwardly facing surface of the supporting member 11, this is not intended to limited the scope of the invention. Although not shown separately, a pair of spacers with a same height may be provided separate from each other on the upwardly facing surface of the supporting member 11 such that the downwardly facing surface of the vibrating member 12 placed on these spacers will form a gap of a uniform width with the portion of the upwardly facing surface of the supporting member 11 between the pair of spacers.

There is provided a pair of planar electrodes (herein referred to as the first electrode 13 and the second electrode 14) securely affixed respectively to the upwardly facing surface of the supporting member 11 and to the downwardly facing surface of the vibrating member 12. These electrodes 13 and 14 may be formed by metallic deposition such as plating or physical vacuum deposition sputtering onto the electrically non-conductive material or materials of the members 11 and 12. They can also be discrete elements, joined to the members 11 and 12 by brazing, soldering, gluing or diffusion bonding. They are formed such that there is a gap between their mutually oppositely facing surfaces and that this gap has normally a uniform width.

Explained broadly, vibration damping devices of this invention, with electrodes thus attached to the mutually oppositely facing surfaces of a supporting member and a vibrating member supported thereon, are provided with a displacement sensor for detecting the vibratory motion of the vibrating member and a controller for applying an electrical time-dependent damping force between these electrodes according to a timing in response to an output from the displacement sensor such that the vibration of the vibrating member will be attenuated. Displacement sensors of different types may be used such as optical sensors and capacitive sensors. Electrical forces of different types may be applied in different manners by the controller. This is why devices of many different kinds are to be considered within the scope of this invention. As many of the examples as practical will be described below, but the illustrated examples are not intended to limit the scope of the invention.

FIG. 1 shows schematically an optical displacement sensor 20 for outputting a signal indicative of the displacement, or the distance between the supporting member 11 and the vibrating member 12. An optical displacement sensor of any available type may be used for the purpose of this invention and hence its structure and functions will not be described in detail. The expression “displacement” is intended to be interpreted in its broadest sense. For the purpose of this invention, the signal outputted from this sensor should at least indicate whether the vibrating member 12 is moving towards or away from the supporting member 11 at any given time, or whether the gap between the supporting member 11 and the vibrating member 12 is increasing or decreasing.

FIG. 2 is an alternative embodiment characterized as using a capacitive displacement sensor 30 to output a signal indicative of the motion of the vibrating member 12 with respect to the supporting member 11. According to the example shown in FIG. 2, a planar capacitance producing electrode 15 is formed on the upwardly facing surface of the supporting member 11 adjacent to but separate from the first electrode 13 such that both the capacitance producing electrode 15 and the first electrode 13 are in a face-to-face relationship with the second electrode 14 on the downwardly facing surface of the vibrating member 12 and a gap of the same width therewith. The capacitive displacement sensor 30 is connected to both the capacitance producing electrode 15 and the second electrode 14 and serves to output a signal indicative of the capacitance therebetween. Since the capacitance between the capacitance producing electrode 15 and the second electrode 14 depends on the separation therebetween, signals outputted by the capacitive displacement sensor 30 indicative of the measured capacitance are also indicative of the separation therebetween at the time.

As an alternative, a similar capacitance producing electrode may be provided instead on the downwardly facing surface of the vibrating member 12 facing the first electrode 13 and separate from the second electrode 14. As another alternative, two capacitance producing electrodes may be provided opposite each other, one affixed to the upwardly facing surface of the supporting member 11 and separate from the first electrode 11 and the other affixed to the downwardly facing surface of the supporting member 12 and separate from the second electrode 12. These alternatives are not separately illustrated but are equally adapted to serve as a portion of a capacitive displacement sensor for outputting a signal indicative of the capacitance and hence the distance of separation therebetween.

In both FIGS. 1 and 2, numeral 50 indicates a controller connected to both the first electrode 13 and the second electrode 14. The controller 50 is also connected to the optical displacement sensor 20 in the case of the embodiment shown in FIG. 1 and to the capacitive displacement sensor 30 in the case of the embodiment shown in FIG. 2 so as to receive signals therefrom and to thereby monitor the distance of separation, as well as to detect the direction of its change, at each moment. The purpose of the controller 50 is to apply a time-dependent electrical force, or more specifically an attractive or repulsive Coulomb force between the first electrode 13 and the second electrode 14 such that the vibratory motion of the vibrating member 12 can be damped. This can be accomplished in many different ways but the basic principle is simple. When the vibrating member 12 is undergoing a vibratory motion, the separation between the first electrode 13 and the second electrode 14 alternately increases and decreases, if not exactly in a sinusoidal way. If a repulsive electric force is applied between the first and second electrodes 13 and 14 while the separation therebetween is decreasing and/or if an attractive electric force is applied therebetween while the separation therebetween is increasing, it is well known that the vibration is damped. The controller 50 is operated on this principle.

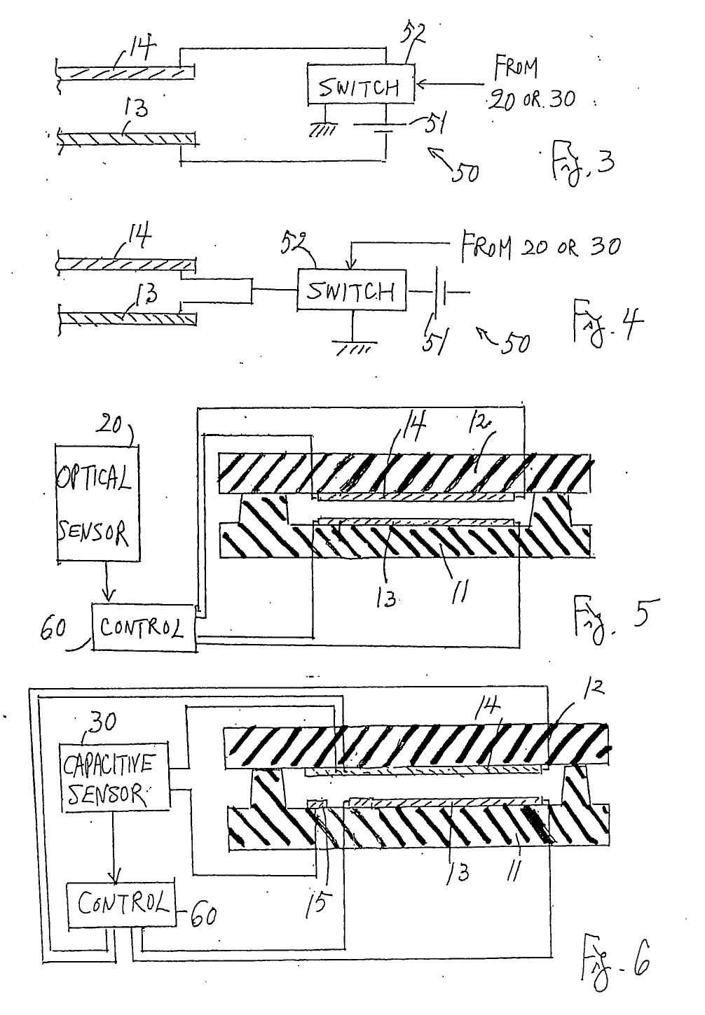

For applying an attractive force between the first and second electrodes 13 and 14 while the separation therebetween is increasing, without attempting to apply any repulsive force therebetween while the separation therebetween is decreasing, the controller 50 may comprise, as shown in FIG. 3, a constant voltage source 51 such as a battery and a switch unit 52 connected in series between the first and second electrodes 13 and 14. The switch unit 52 is adapted to receive the signals from the displacement sensor 20 or 30 and serves to ground both the first and second electrodes 13 and 14 when the signals being received indicate that the separation is decreasing and to connect the voltage source 51 therebetween when the signals indicate that the separation is increasing. If both electrodes 13 and 14 are grounded, there is no electrostatic attractive force between the first and second electrodes 13 and 14, and there is no damping effect on the vibratory motion of the vibrating member 12. While the voltage source 51 is connected, however, a voltage difference depending upon the constant voltage source 51 is applied between the first and second electrodes 13 and 14, translating into an attractive force therebetween which serves to damp the vibratory motion of the vibrating member 12. In other words, the damping takes place during one-half period of each cycle of the vibration.

Alternatively, the first and second electrodes 13 and 14 may be connected in parallel to the switch unit 52, as shown in FIG. 4. In this example, the electrodes 13 and 14 are both grounded while the distance therebetween is increasing and there is no damping effect but they are both connected to the same pole of the voltage source 51 while the distance between the electrodes 13 and 14 is decreasing such that both electrodes 13 and 14 are charged in the same polarity and the electric force therebetween is repulsive, serving to damp the vibratory motion of the vibrating member 12. In this example, too, the damping takes place during one-half period of each cycle of the vibration.

There are still other alternatives, inclusive of those that are more complicated, although they are not separately illustrated. The controller 50 may be so designed, for example, as to vary the voltage difference to be applied between the first and second electrodes 13 and 14 from one moment to another, depending on the rate at which the separation therebetween is changing. In all cases, however, care must be taken that the electrostatic field inside the gap will not be so large at any moment as to cause a discharge.

FIG. 5 shows another vibration damping device according to a different embodiment of the invention, similar to the device described above with reference to FIG. 1 but different therefrom wherein its controller 60 operates differently to damp vibratory motion of the vibrating member 12. To be more specific, the controller 60 according to this embodiment serves to cause an electric current to flow through each of the first and second electrodes 13 and 14 such that the currents flowing therethrough are selectively either parallel (in same directions) to generate an attractive force or antiparallel (in opposite directions) to generate a repulsive force therebetween. For this reason, the first and second electrodes 13 and 14 may be formed similarly as described above with reference to FIG. 1 but are preferably of an elongated shape, extending in the same direction, and the controller 60 may include a current source such as a battery and a switch. The switch circuit may be structured, for example, such that a current due to the battery always flows in a specified direction through the first electrode 13 but the direction of the current through the second electrode 14 is reversible by operating the switch. Such a circuit structure is well known and hence will not be described or illustrated.

FIG. 6 shows still another vibration damping device similar to the example described above with reference to FIG. 5 except that a capacitive displacement sensor 30 is used instead of the optical sensor 20 used in the device shown in FIG. 5. The controller 60 is connected to the optical sensor 20 in the case of FIG. 5 and to the capacitive displacement sensor 30 in the case of FIG. 6 so as to receive signals indicative of the separation between the first and second electrodes, or the direction in which it is instantaneously changing. When the received signal indicates that the first and second electrodes 13 and 14 are approaching each other, the controller 60 operates the switch such that the currents through the first and second electrodes 13 and 14 are antiparallel to each other and hence that a repulsive force will operate therebetween. When the received signal indicates that the first and second electrodes 13 and 14 are moving away from each other, the controller 60 operates such that the currents through the first and second electrodes 13 and 14 flow in the same direction and hence that an attractive force operates therebetween. As discussed above, this mode of applying attractive and repulsive forces between the electrodes 13 and 14 and hence between the supporting member 11 and the vibrating member 12 tends to damp the vibratory motion of the vibrating member 12.

For the sake of convenience, the attractive and repulsive forces between parallel and antiparallel currents are herein also referred to as an electrical force in a broad sense of the expression, say, as opposed to mechanical force.

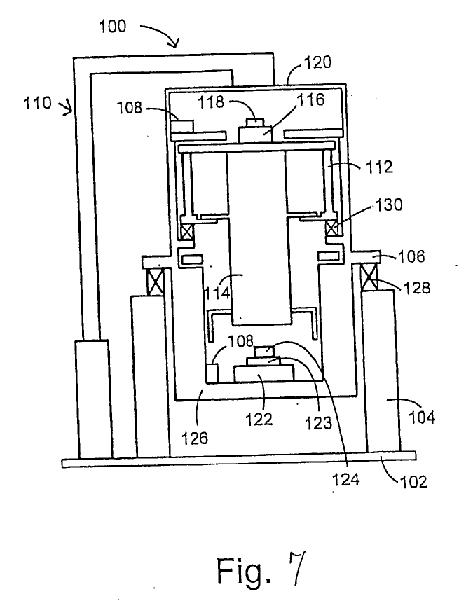

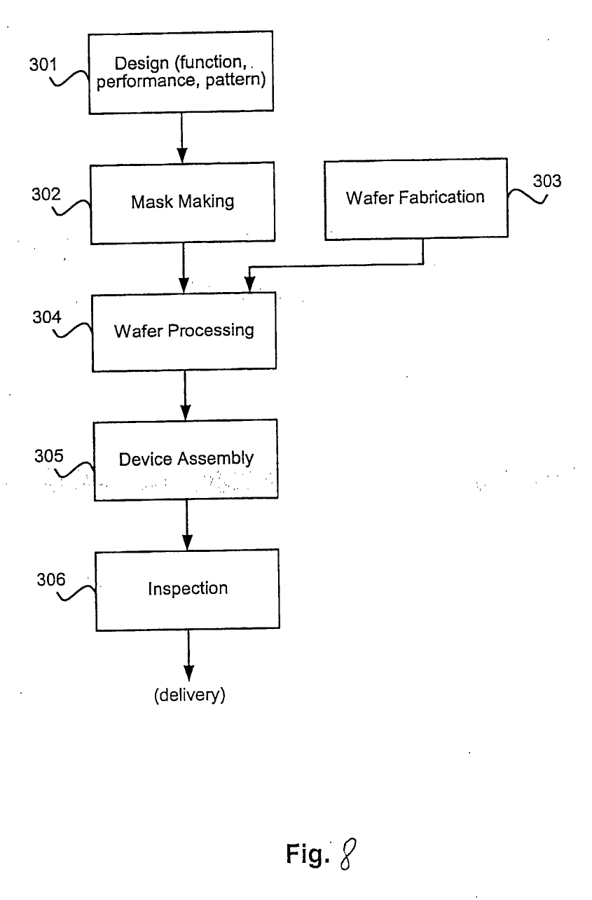

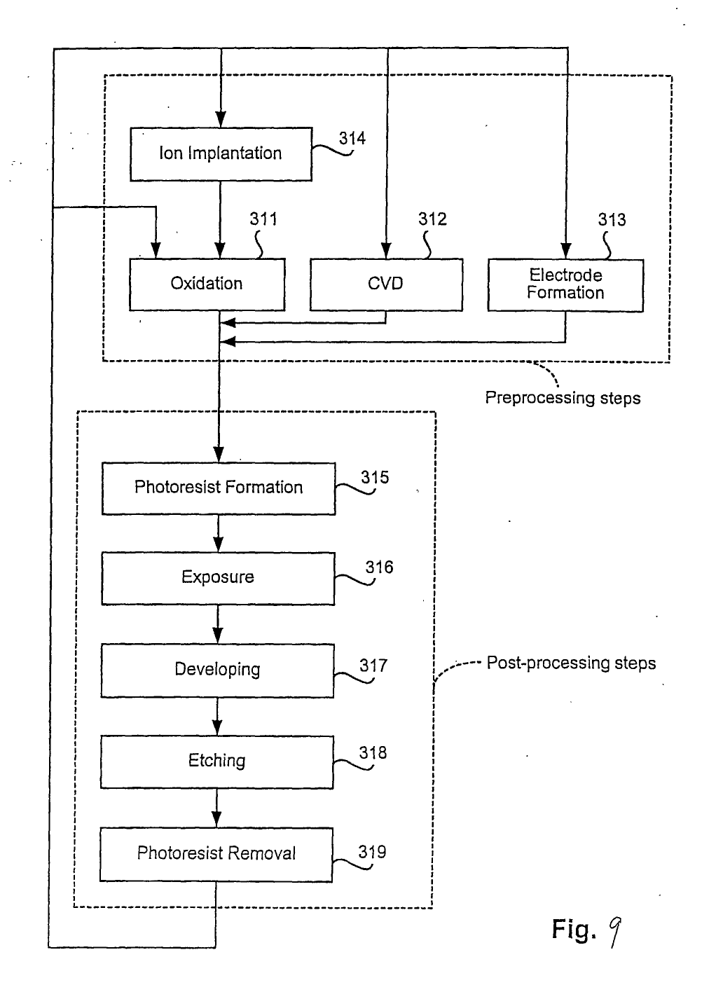

FIG. 7 shows a typical lithographic exposure apparatus 100 incorporating vibration damping devices of this invention, comprising a mounting base 102, a support frame 104, a base frame 106, a measurement system 108, a control system (not shown), an illumination system 110, an optical frame 112, an optical device 114, a reticle stage 116 for retaining a reticle 118, an upper enclosure 120 surrounding the reticle stage 116, a wafer stage 122, a wafer table 123 for retaining a semiconductor wafer workpiece 124, and a lower enclosure 126 surrounding the wafer stage 122.

The support frame 104 typically supports the base frame 106 above the mounting base 102 through a base vibration isolation system 128. The base frame 106 supports the optical frame 112 through an optical vibration isolation system 130. The base frame 106 further supports the measurement system 108, the upper enclosure 120, the wafer stage 122, and the lower enclosure 126 above the support frame 104. The wafer stage 122 supports the wafer table 123. The optical frame 112 supports the reticle stage 116 and the optical device 114. The optical frame 112 in turn supports the optical device 114 and the reticle stage 116 above the base frame 106 through the optical vibration isolation system 130. As a result, the optical frame 112, the components supported thereby and the base frame 106 are effectively attached in series through the base vibration isolation system 128 and the optical vibration isolation system 130 to the mounting base 102. The vibration isolation systems 128 and 130 are designed to damp and isolate vibrations between components of the exposure apparatus 100 and comprise a vibration damping device of this invention described above. The measurement system 108 monitors the positions of the stages 116 and 122 relative to a reference such as the optical device 114 and outputs position data to the control system. The optical device 114 typically includes a lens assembly that projects and/or focuses the light or beam from the illumination system 110 that passes through the reticle 118. The reticle stage 116 is attached to one or more movers (not shown) directed by the control system to precisely position the reticle 118 relative to the optical device 114. Similarly, the wafer stage 122 includes one or more movers (not shown) to precisely position the wafer workpiece 124 with the wafer table 123 relative to the optical device (lens assembly) 114.

As will be appreciated by those skilled in the art, there are a number of different types of photolithographic devices. For example, exposure apparatus 100 can be used as a scanning type photolithography system which exposes the pattern from reticle 118 onto wafer 124 with reticle 118 and wafer 124 moving synchronously. In a scanning type lithographic device, reticle 118 is moved perpendicular to an optical axis of optical device 114 by reticle stage 116 and wafer 124 is moved perpendicular to an optical axis of optical device 114 by wafer stage 122. Scanning of reticle 118 and wafer 124 occurs while reticle 118 and wafer 124 are moving synchronously.

Alternatively, exposure apparatus 100 can be a step-and-repeat type photolithography system that exposes reticle 118 while reticle 118 and wafer 124 are stationary. In the step and repeat process, wafer 124 is in a constant position relative to reticle 118 and optical device 114 during the exposure of an individual field. Subsequently, between consecutive exposure steps, wafer 124 is consecutively moved by wafer stage 122 perpendicular to the optical axis of optical device 114 so that the next field of semiconductor wafer 124 is brought into position relative to optical device 114 and reticle 118 for exposure. Following this process, the images on reticle 118 are sequentially exposed onto the fields of wafer 124 so that the next field of semiconductor wafer 124 is brought into position relative to optical device 114 and reticle 118.

However, the use of exposure apparatus 100 provided herein is not limited to a photolithography system for a semiconductor manufacturing. Exposure apparatus 100, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines. The present invention is desirable in machines where it is desirable to prevent the transmission of vibrations.

The illumination source (of illumination system 110) can be g-line (436 nm), i-line (365 nm), KrF excimer laser (248 nm), ArF excimer laser (193 nm) and F₂ laser (157 nm). Alternatively, the illumination source can also use charged particle beams such as x-ray and electron beam. For instance, in the case where an electron beam is used, thermionic emission type lanthanum hexaboride (LaB₆,) or tantalum (Ta) can be used as an electron gun. Furthermore, in the case where an electron beam is used, the structure could be such that either a mask is used or a pattern can be directly formed on a substrate without the use of a mask.

With respect to optical device 114, when far ultra-violet rays such as the excimer laser is used, glass materials such as quartz and fluorite that transmit far ultra-violet rays is preferably used. When the F₂ type laser or x-ray is used, optical device 114 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. Pat. No. 5,892,117 also use a reflecting-refracting type of optical system incorporating a concave mirror, etc., but without a beam splitter, and can also be employed with this invention. The disclosures in the above mentioned U.S. patents, as well as the Japan patent applications published in the Official Gazette for Laid-Open Patent Applications are incorporated herein by reference.

Further, in photolithography systems, when linear motors (see U.S. Pat. Nos. 5,623,853 or 5,528,118) are used in a wafer stage or a reticle stage, the linear motors can be either an air levitation type employing air bearings or a magnetic levitation type using Lorentz force or reactance force. Additionally, the stage could move along a guide, or it could be a guideless type stage which uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces which can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As described above, a photolithography system according to the above described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

Further, semiconductor devices can be fabricated using the above described systems, by the process shown generally in FIG. 8. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system such as the systems described above. In step 305 the semiconductor device is assembled (including the dicing process, bonding process and packaging process), then finally the device is inspected in step 306.

FIG. 9 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 315 (photoresist formation step), photoresist is applied to a wafer. Next, in step 316, (exposure step), the above-mentioned exposure device is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed. Multiple circuit patterns are formed by repetition of these preprocessing and post-processing steps.

It should be appreciated that various embodiments of the present invention described above by referring to FIGS. 1-6 may be utilized and/or incorporated with apparatus and methods described referring to FIGS. 7-9.

The invention has been described above by way of only a limited number of examples and as applied to a lithography exposure apparatus, but these examples are not intended to limit the scope of the invention. Many modifications and variations are possible within the scope of the invention. The disclosure is intended to be interpreted broadly. For example, the vibrating member and the supporting member need not be in vertical relationship, that is, their mutually opposite surfaces need not necessarily be upwardly or downwardly facing. Expressions such as one member supporting another member are also intended to be interpreted broadly, not being limited to situations where these are separate members placed one on top of the other. FIG. 10 shows a particular example of an optical component that may conveniently be incorporated in a lithographic exposure apparatus for reflecting a beam of radiation (light) in a lithographic exposure process such as described above. FIG. 10 shows a so-called mirror bar (or its main frame) 70 with a mirror surface 72 supported by a stage 75, say, a component of the optical device 114 of the lithographic exposure apparatus shown in FIG. 7. The mirror surface 72 reflects measurement beam from a measurement system 108 for detecting the positions or motions of the stage 75 relative to the reference such as the optical device 114 regarding at least one of the moving direction of the stage 75. In this case, the first surface of the stage 75 and the second surface of the mirror bar 70 are substantially perpendicular to the at least one of the moving directions of the stage 75 as shown in FIG. 10. Further, the first and second surfaces are substantially perpendicular to the direction that the measurement beam makes incidence on the mirror surface 72. For this purpose, the mirror bar 70 embodying this invention is characterized as incorporating any of the vibration damping devices of this invention described above.

In summary, the disclosure is intended to be interpreted broadly. All such modifications and variations of the disclosed examples that may be apparent to a person skilled in the art are intended to be within the scope of this invention.

What is claimed is:

1. An apparatus, comprising:
a first electrode attached to a first surface of a supporting member;
a second electrode attached to a second surface of a vibrating member, said first electrode and said second electrode defining a gap therebetween;
a displacement sensor that outputs a signal indicative of a change in said width of said gap caused by vibrations of said vibrating member; and
a controller connected to the first electrode, the second electrode and the displacement sensor, the controller configured to receive said signal from said displacement sensor and to apply an electrical force between said first electrode and said second electrode according to said signal so as to damp said vibrations.

2. The apparatus of claim 1 wherein said controller applies a specified voltage to at least one of said first electrode and said second electrode in a time-dependent manner.

3. The apparatus of claim 1 wherein said controller causes electric currents to flow through said first electrode and said second electrode in parallel and antiparallel directions.

4. The apparatus of claim 1 wherein said displacement sensor is a capacitive displacement sensor serving to measure the capacitance between two electrodes affixed individually to said first surface and said second surface.

5. The apparatus of claim 1 wherein said displacement sensor is an optical displacement sensor.

6. The apparatus of claim 2 wherein said controller includes a voltage source that applies a constant voltage and a switch that applies said constant voltage to at least a selected one of said first electrode and said second electrode in said time-dependent manner.

7. The apparatus of claim 2 wherein said controller includes a voltage source that applies a constant voltage difference and a switch that applies said constant voltage between said first electrode and said second electrode in said time-dependent manner.

8. The apparatus of claim 3 wherein said controller includes a current source that causes said electric currents to flow through said first electrode and said second electrode and a switch that passes said currents selectively parallel or antiparallel to each other in a time-dependent manner according to said signal.

9. A method of damping vibrations of a vibrating member supported by a supporting member, said supporting member having a first surface, said vibrating member having a second surface, said method comprising the steps of:
attaching a first electrode on said first surface of said supporting member;
attaching a second electrode on said second surface of said vibrating member, said first electrode and said second electrode defining a gap therebetween with a specified width;
generating a signal indicative of a change in said width of said gap caused by a vibration of said vibrating member; and
applying an electrical force between said first electrode and said second electrode according to said signal so as to damp said vibration.

10. The method of claim 9 wherein said electrical force is an electrostatic force and is applied by applying a specified voltage to at least one of said first and second electrodes in a time-dependent manner.

11. The method of claim 9 wherein said electrical force is applied by causing electric currents to flow through said first electrode and said second electrode selectively in parallel and antiparallel directions in a time-dependent manner.

12. The method of claim 9 wherein said signal is generated by detecting said gap by an optical sensor.

13. The method of claim 9 wherein said signal is generated by detecting said gap capacitively by measuring capacitance between two electrodes placed respectively on said first and second surfaces.

14. A lithography exposure apparatus comprising:
a base frame supporting a workpiece, said base frame including a first member having a first facing surface;
an optical frame supporting an optical device that irradiates said workpiece with radiative energy, said optical frame including a second member supported by said first member, said second member having a second;
a first electrode attached to said first surface of said first member;
a second electrode attached to said second surface of said second member, said first electrode and said second electrode defining a gap therebetween;
a displacement sensor that outputs a signal indicative of a change in said width of said gap caused by vibrations of said second member with respect to said first member; and
a controller connected to the first electrode, the second electrode, and the displacement sensor, the controller receiving said signal from said displacement sensor and applying an electrical force between said first electrode and said second electrode according to said signal so as to dampen said vibrations.

15. An object manufactured with the lithography exposure apparatus of claim 14.

16. A wafer on which an image has been formed by the lithography exposure apparatus of claim 14.

17. A method for making an object using a lithography exposure apparatus of claim 14.

18. A method of patterning a wafer using a lithography process, wherein the lithography process utilizes a lithography exposure apparatus as recited in claim 14.

19. An apparatus comprising:
a wafer table having a first electrode;
a mirror assembly affixed to the wafer table, the mirror assembly having a second electrode, the first electrode and the second electrode defining a gap between the mirror assembly and the wafer table;
a displacement sensor that generates an output signal indicative of a change in the width of the gap caused by vibrations between the wafer table and the mirror assembly; and
a controller connected to the first and second electrodes and the displacement sensor, the controller configured to receive the output signal from the displacement sensor and to apply an electrical force between the first electrode and the second electrode according to the output signal.

20. The apparatus of claim 19, wherein the displacement sensor generates the output signal indicative of changes in the gap width by measuring changes in the capacitance between the first electrode and the second electrode.

21. The apparatus of claim 19, wherein the first electrode is attached to a first surface of said wafer table, the second electrode is attached to a second surface of said mirror assembly, the first surface and the second surface are substantially parallel and oppositely facing.

22. The apparatus of claim 21 further comprising:
a mirror attached to the mirror assembly, the mirror having a reflecting surface substantially parallel to the second surface of the mirror assembly; and
a measurement system configured to generate a measurement beam that makes incidence onto the mirror substantially perpendicularly to the reflecting surface.
